(19) United States
(12) Patent Application Publication
(10) Pub. No.: US 2014/0230622 A1
(43) Pub. Date: Aug. 21, 2014

(54) CUTTING DEVICE FOR CUTTING RESIDUAL RUNNER OF LENSES

(71) Applicant: HON HAI PRECISION INDUSTRY CO., LTD., New Taipei (TW)

(72) Inventor: CHIH-HAO CHU, New Taipei (TW)

(73) Assignee: HON HAI PRECISION INDUSTRY CO., LTD., New Taipei (TW)

(21) Appl. No.: 13/967,351

(22) Filed: Aug. 15, 2013

(30) Foreign Application Priority Data
Feb. 21, 2013 (TW) 102106099

(51) Int. Cl. B29D 11/00

(52) U.S. Cl. CPC B29D 11/00432
USPC 83/467.1

(57) ABSTRACT

A cutting device includes a bearing seat, a positioning seat, and a guiding element. The bearing seat includes a first seat and a second seat connected to the first seat. The first seat includes a top surface and a connecting surface. The first seat has a height greater than a height of the second seat. The connecting surface connects to the second seat. The first seat defines a guiding hole on the top surface and a cutting hole on the connecting surface. The cutting hole communicates with the guiding hole. The positioning seat is positioned on the second seat and defines a receiving recess for receiving a lens. The guiding element is movably received in the guiding hole and defines a notch in a cylindrical surface thereof.

### BACKGROUND

1. Technical Field

The present disclosure relates to cutting devices, and particularly to a cutting device for cutting off residual runners of lenses.

2. Description of Related Art

Lenses are connected to each other by a runner when formed by a multi-cavity mold. The lenses are separated from each other by cutting off the runner. However, a small part of the runner may still reside on the lenses after cutting.

Therefore, it is desirable to provide a cutting device that can overcome the limitations described.

### BRIEF DESCRIPTION OF THE DRAWINGS

FIG. 1 is an isometric view of a cutting device in accordance with an exemplary embodiment.

FIG. 2 is an isometric, exploded, and schematic view of the cutting device of FIG. 1.

### DETAILED DESCRIPTION

Embodiments of the disclosure will be described with reference to the drawings.

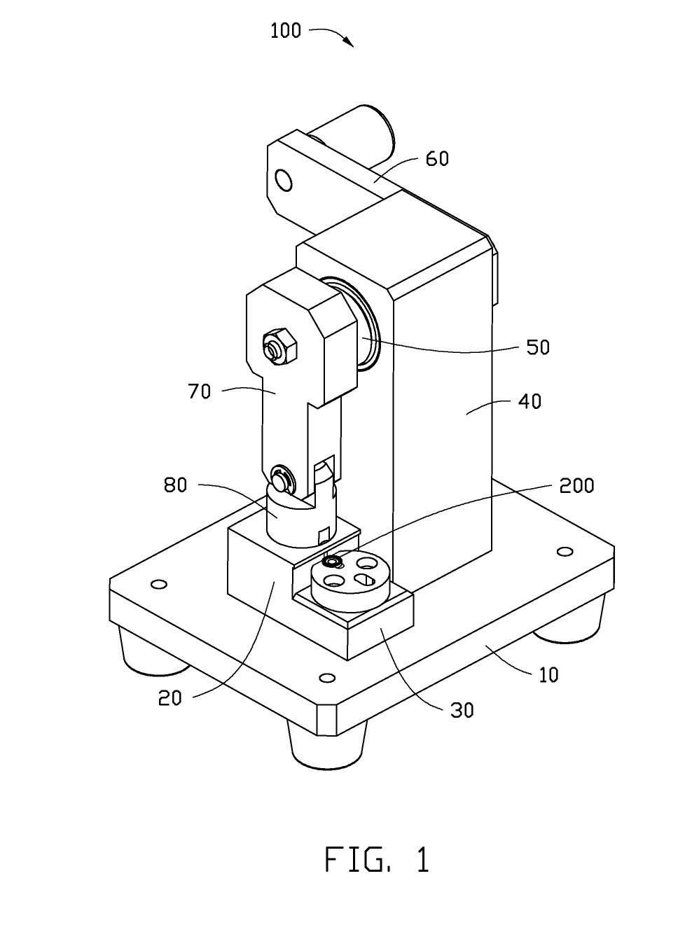

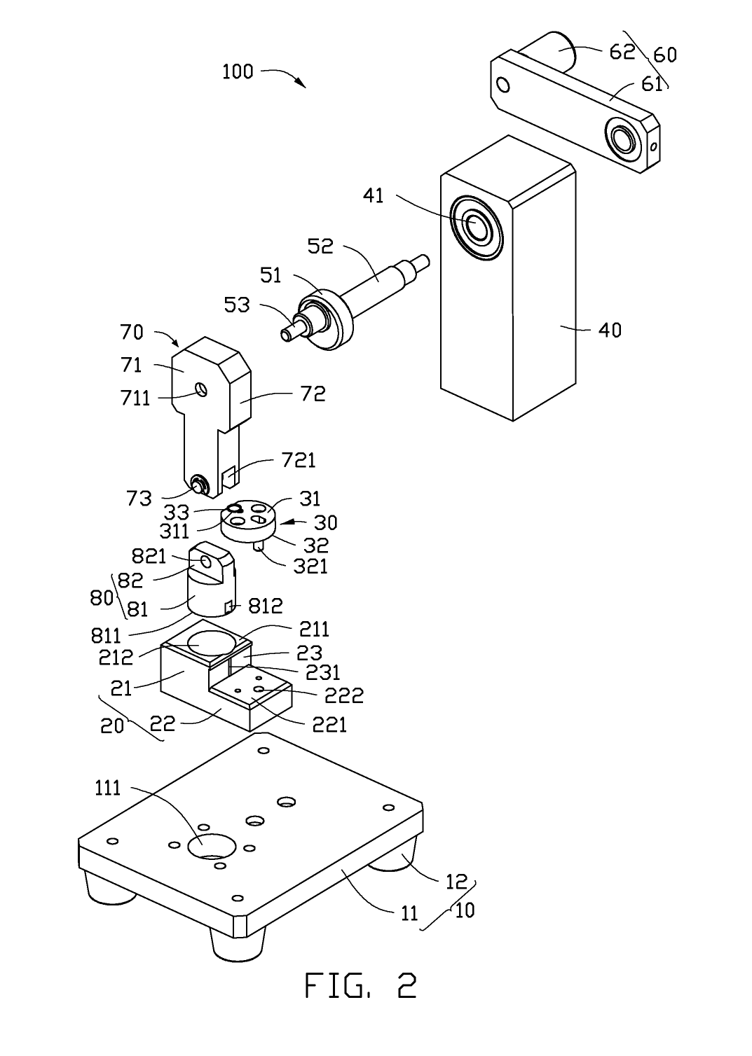

FIGS. 1-2 show a cutting device 100 according to an exemplary embodiment. The cutting device 100 includes a base 10, a bearing seat 20, a positioning seat 30, a supporting seat 40, a shaft 50, an operating element 60, a connecting element 70, and a guiding element 80. The cutting device 100 is used to cut a residual runner from a lens 200.

The base 10 includes a bottom plate 11 and four supporting legs positioned at four corners of the bottom plate 11. The bottom plate 11 defines a through hole 111.

The bearing seat 20 is positioned on the base 10, and includes a first seat 21 and a second seat 22 connected to the first seat 21. The first seat 21 is higher than the second seat 22. The first seat 21 includes a first top surface 211 opposite to the base 10, and the second seat 22 includes a second top surface 221 opposite to the base 10. The first top surface 211 and the second top surface 221 are substantially parallel to the base 10. The first seat 21 includes a connecting surface 23 connected between the first top surface 211 and the second top surface 221. The first seat 21 defines a guiding hole 212 on the first top surface 211, and a cutting hole 231 on the connecting surface 23. An extending direction of the guiding hole 212 is substantially perpendicular to the base 10. The cutting hole 231 communicates with the guiding hole 212. The second seat 22 defines a positioning hole 222 on the second top surface 221. In the embodiment, the positioning hole 222 is substantially cylindrical.

The positioning seat 30 is cylindrical and is positioned on the second seat 22. The positioning seat 30 includes a first operation surface 31, a lower surface 32 opposite to the first operation surface 31, and a positioning surface 33 substantially perpendicularly connected between the first operation surface 31 and the lower surface 32. The first operation surface 31 and the lower surface 32 are substantially parallel to the base 10. The positioning surface 33 is formed by cutting the positioning seat 30 along a direction perpendicular to the first operation surface 31. The positioning seat 30 defines a receiving recess 311 on the first operation surface 31 and adjacent to the positioning surface 33. A positioning pole 321 extends downward from the lower surface 32. The positioning seat 30 is positioned on the second top surface 221. The positioning pole 321 is received in the positioning hole 222. The positioning surface 33 contacts with the connecting surface 23.

The supporting seat 40 is substantially rectangular and is positioned substantially perpendicularly on the base 10. The supporting seat 40 defines a first shaft hole 41 in an end away from the base 10. An extending direction of the first shaft hole 41 is substantially parallel to the connecting surface 23.

The shaft 50 includes a wheel body 51, a first axle 52 centrally positioned on a side of the wheel body 51, and a second axle 53 positioned off-center at an opposite side of the wheel body 51. An axis of the first axle 52 is nonlinear with an axis of the second axle 53. The first axle 52 is received in the first shaft hole 41.

The operating element 60 is substantially L-shaped and includes a transmitting pole 61 and a handle 62 substantially perpendicularly connected to one end of the transmitting pole 61. One end of the transmitting pole 61 away from the handle 62 is connected to one end of the first axle 52 away from the wheel body 51. The handle 62 and the first axle 52 are positioned at two opposite sides of the transmitting pole 61. The transmitting pole 61 forms a crank arm.

The connecting element 70 includes two opposite first side surfaces 71 and two opposite second side surfaces 72. The first side surfaces 71 are perpendicular to the second side surfaces 72. The connecting element 70 defines a second shaft hole 711 penetrating the first side surfaces 71. The second shaft hole 711 is defined in one end of the connecting element 70. The connecting element 70 defines a connecting recess 721 in another end thereof, and the connecting recess 721 penetrates the second side surfaces 72. The connecting element 70 is rotatably connected to the shaft 50 via the second axle 53. The second axle 53 is received in the second shaft hole 711. A connecting axle 73 is fixed in the connecting recess 721 along a direction perpendicular to the first side surface 71.

The guiding element 80 includes a main body 81 and a connecting portion 82 extending upward from one end of the main body 81. The connecting portion 82 defines a third shaft hole 821. The main body 81 is cylindrical and includes a second operation surface 811 corresponding to the first operation surface 31. The second operation surface 811 is substantially parallel to and faces the base 10. The main body 81 defines a notch 812 in the second operation surface 811. The notch 812 extends along a cylindrical surface of the main body 81, and a shape of the notch 812 corresponds to an external contour of the lens 200. The guiding element 80 is connected to the connecting element 70 via the connecting axle 73. The connecting axle 73 is rotatably received in the third shaft hole 821. The main body 81 is movably received in the guiding hole 212.

In use, the lens 200 having a residual runner is placed in the receiving recess 311 of the positioning seat 30. The position of the lens 200 is adjusted so that the residual runner of the lens 200 protrudes into the guiding hole 212 through the cutting hole 231. The handle 62 of the operating element 60 is rotated around a clockwise direction or an anticlockwise direction by an operator. The operating element 60 drives the shaft 50 to rotate by rotating the first axle 52. The shaft 50 drives the connecting element 70 to rotate around the second axle 53. The connecting element 70 simultaneously moves up/down and side to side. As the main body 81 is received in the guiding hole 212, and the connecting element 70 is connected to the guiding element 80, the guiding element 80 is limited to move only up or down. The second operation surface 811 forms a cutting surface with the first operation surface 31. The notch 812 cuts the residual runner protruding into the cutting hole 231 from the lens 200. The residual runner cut from the lens 200 drops from the guiding hole 212 and through the through hole 111.

In the embodiment, as the shape of the notch 812 corresponds to an external contour of the lens 200, the residual runner can be wholly cut off from the lens 200.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A cutting device, comprising:
a base;
a bearing seat positioned on the base, and comprising a first seat and a second seat connected to the first seat, the first seat comprising a top surface and a connecting surface, the first seat having a height greater than a height of the second seat, the connecting surface connecting to the second seat, the first seat defining a guiding hole on the top surface and a cutting hole on the connecting surface, the cutting hole communicating with the guiding hole;
a positioning seat positioned on the second seat, and configured for receiving a lens;
a supporting seat positioned on the base, and defining a first shaft hole, the first shaft hole adjacent to an end of the supporting seat and distant from the base;
a shaft comprising a first axle and a second axle nonlinear with the first axle, the first axle received in the first shaft hole; and
a guiding element rotatably connected to the second axle and received in the guiding hole, the shaft driving the guiding element to move up and down in the guiding hole.

2. The cutting device of claim 1, wherein the positioning seat comprises a first operation surface opposite to the second seat, and defining a receiving recess on the first operation surface.

3. The cutting device of claim 2, wherein the guiding element comprises a second operation surface facing the base, and defines a notch in the second operation surface and extending through its cylindrical surface, a shape of the notch corresponds to an external contour of the lens.

4. The cutting device of claim 3, wherein the positioning seat comprises a positioning surface perpendicularly connected to the first operation surface, and the positioning surface touches the connecting surface.

5. The cutting device of claim 1, comprising a connecting element connected between the second axle and the guiding element, wherein the connecting element defines a second shaft hole adjacent to one end thereof, the second axle is received in the second shaft hole.

6. The cutting device of claim 1, wherein the shaft comprises a wheel body, the first axle and the second axle are positioned at two opposite sides of the wheel body.

7. The cutting device of claim 6, comprising an operating element connected to one end of the first axle away from the wheel body.

8. The cutting device of claim 7, wherein the operating element comprises a transmitting pole and a handle perpendicularly connected to one end of the transmitting pole, another end of the transmitting pole is connected to the first axle.

9. A cutting device, comprising:
a bearing seat comprising a first seat and a second seat connected to the first seat, the first seat comprising a top surface and a connecting surface, the first seat having a height greater than a height of the second seat, the connecting surface connecting to the second seat, the first seat defining a guiding hole on the top surface and a cutting hole on the connecting surface, the cutting hole communicating with the guiding hole;
a positioning seat positioned on the second seat, and defining a receiving recess; and
a guiding element movably received in the guiding hole, and defining a notch extending through its cylindrical surface.
